(19) United States
(12) Patent Application Publication
(10) Pub. No.: US 2026/0001088 A1
(43) Pub. Date: Jan. 1, 2026

(54) AUTOMATIC CENTRIFUGE

(71) Applicant: Eppendorf Himac Technologies Co., Ltd., Ibaraki (JP)

(72) Inventors: Hidetaka Osawa, Ibaraki (JP); Teruo Suzuki, Ibaraki (JP)

(73) Assignee: Eppendorf Himac Technologies Co., Ltd., Ibaraki (JP)

(21) Appl. No.: 18/880,834

(22) PCT Filed: Jul. 27, 2023
(86) PCT No.: PCT/JP2023/027491

§ 371 Date: Jan. 2, 2025

(30) Foreign Application Priority Data
Aug. 5, 2022 (JP) 2022-125191

(51) Int. Cl. B04B 11/04; B04B 5/04; B04B 9/10; B04B 9/14

(52) U.S. Cl. CPC B04B 11/04; B04B 5/0414; B04B 9/10; B04B 9/14; B04B 2011/046

(57) ABSTRACT

In an automatic centrifuge, by changing an initial loading bucket position of a rack automatically conveyed over for each centrifugal separation operation, a load on each bucket is equalized. In an automatic centrifuge including a handling apparatus that automatically performs mounting and removal of racks loaded with specimen accommodating containers into and from buckets, a control device changes an initial bucket to load the rack depending on whether the centrifugal separation operation is a centrifugal separation operation of an odd-numbered time or an even-numbered time. During a centrifugal separation operation of an odd-numbered time, loading of the racks starts from circled 1 of a bucket A. During a centrifugal separation operation of an even-numbered time, loading of the racks starts from circled 3 of a bucket B.

### TECHNICAL FIELD

The present invention relates to an automatic centrifuge that, when performing centrifugal separation on specimen samples such as urine and blood, automatically carries in and out the specimen samples by a handling apparatus without human manual intervention and then performs centrifugal separation thereon.

### RELATED ART

In a conventional automatic centrifuge, a handling apparatus is provided in a centrifuge performing centrifugal separation on specimen samples, and a hand provided at the handling apparatus transports racks with the specimen samples placed therein to move the racks in and out from above the centrifuge. FIG. 10 is a view showing a basic configuration of a conventional automatic centrifuge 201. As shown in FIG. 10, a swing rotor 240 of an automatic centrifuge 201 and multiple buckets 250 storing specimen samples are included, and each bucket 250 is capable of being loaded with multiple racks 60. The rack 60 has multiple mounting holes formed for storing tubular specimen accommodating containers 70, and one or more specimen accommodating containers 70 may be inserted into the mounting holes. The specimen accommodating container 70 is, for example, a vacuum blood collection tube for accommodating human blood. The rack 60 accommodating the specimen accommodating containers 70 is a unit that is automatically transported via a conveyance line 45, and is conveyed, by the conveyance line 45, from a conveyance start point (not shown) in a direction of an arrow 46a, and stopped at a position (carry-in/out position) indicated by the rack 60 in FIG. 10. Upon stop of the rack 60 at the carry-in/out position, a rack sensor (not shown) detects that the rack 60 is present, and a signal thereof is sent to a control device (not shown).

The handling apparatus 220 transports the rack 60 from the carry-in/out position to the bucket 250 of the automatic centrifuge 201, and returns the rack 60 from the bucket 250 to the conveyance line 45 after the centrifugal separation operation. In other words, the handling apparatus 220 transports between the conveyance start point and the bucket 250 located closest to the handling apparatus 220 by a transport device 222 that transports in a first direction indicated by an arrow 227 and a transport device 223 that transports in a second direction (up-down direction) indicated by an arrow 228. The handling apparatus 220 has a hand 221 that grips a short-side lateral surface of the rack 60. The hand 221 provided at the handling apparatus 220 lowers to a position of the rack 60 at the carry-in/out position (conveyance start point) after start of carry-in to grip the rack 60, transports the rack 60 to above the bucket 250 while maintaining the grip state, and then the hand 221 portion lowers to load the rack 60 to a predetermined position in the bucket 250. During loading of the rack 60 into the bucket 250 by the handling apparatus 220, by rotating the swing rotor 240, the control device (not shown) manages the rotation position of the swing rotor 240 such that a target bucket 250 serving as a loading destination is located below the hand 221 when lowering the transported rack 60.

Upon end of transporting all racks 60 to be loaded into the buckets 250, a door (not shown) is closed to close the rotor room 206, and centrifugal separation operation is performed. After the end of centrifugal separation, the door (not shown) is opened, and transport of the racks 60 to the conveyance line 45 by the hand 221 is started. Specifically, the racks 60 located in the rotor room 206 are sequentially taken out from the buckets 250 by the handling apparatus 220 and returned to the carry-in/out position of the conveyance line 45. The rack 60 returned to the carry-out/in position is transported in a direction of an arrow 46b by a moving body of the conveyance line 45 and delivered to a targeted conveyance destination. The handling apparatus 220 performs carry-out of the racks 60 according to the control device (not shown), and this operation is repeatedly performed until all racks 60 are carried out. Patent Literature 1 and Patent Literature 2 disclose such an automatic centrifuge.

An arrangement of buckets in an automatic centrifuge of Patent Literature 1 is as shown in FIG. 11(a), in which four buckets 250 identified by A to D are mounted on the swing arms of the swing rotor 240. Each bucket 250 is provided with three rack accommodating parts. The bucket A is provided with three rack accommodating parts indicated by circled 1 to circled 3, and similarly, the buckets B to D are each provided with three rack accommodating parts, as indicated by circled 4 to circled 6, circled 7 to circled 9, and circled 10 to circled 12. In the conventional automatic centrifuge 201 shown in FIG. 10, the position and the sequence of placing the racks 60 into the buckets 250 are fixed in advance. In other words, the bucket A is a loading start bucket in the loading sequence of the racks 60. According to the quantity of the racks 60 to be loaded, the racks 60 are loaded in a sequence of “bucket A→bucket C→bucket B→bucket D”. Which bucket among the four buckets 250 is taken as the loading start bucket (bucket A) is set in a rotation angle (e.g., start point of rotation angle 0 degrees) of a motor serving as a drive device.

As shown in FIG. 11(a), in the case where the quantity of the racks is half or less than a maximum loading quantity of 12, an initial rack 60 (rack No. 1) is loaded into circled 1 of the bucket A, and next, a 2nd rack (rack No. 2) is loaded into circled 7 of the bucket C, which is at a position rotationally symmetric to the bucket A. In this manner, according to the total quantity of the racks 60 to be loaded, the racks 60 are sequentially loaded into the buckets 250 in a sequence defined by the table in FIG. 11(b). In the case where the total quantity of the racks to be loaded is an odd number, for example, if there is only one rack 60, a dummy rack is loaded at the position of circled 7 to maintain balance during rotation of the swing rotor 240. Similarly, in the case where three racks are loaded, a dummy rack is loaded at the position of circled 8. The dummy rack (not shown) is a mass body equivalent to an average weight of a bucket including the specimen accommodating containers. The weight of the dummy rack is configured to be, for example, a weight approximately in the middle between a heaviest total weight and a lightest total weight of the rack 60 set with sample containers including samples.

### RELATED ART LITERATURE

### Patent Literature

Patent Literature 1: Japanese Patent Application Laid-Open No. H03-127649
Patent Literature 2: Japanese Patent Application Laid-Open No. H10-244185

### SUMMARY OF INVENTION

### Problem to be Solved by Invention

In the technique of Patent Literature 1, regardless of the quantity of the racks loaded during one-time centrifugal separation operation, the rack or the dummy rack is always loaded into the buckets A and C every time. In this conventional art, because the sequence of taking in the racks is fixed, a cumulative centrifugal load applied to the buckets A and C increases compared to the buckets B and D. In a standard centrifugal separation work of blood specimens, specimens to be centrifugally separated are collected from various hospitals and the like in the morning, and in a department responsible for performing centrifugal separation on the specimens, during an initial operation period of the day, sets of 12 racks are loaded into the buckets A to D to perform centrifugal separation. After centrifugally separating many specimens collected, specimens sequentially delivered over are centrifugally separated sequentially upon each delivery or at a specific quantity. Thus, in the method of Patent Literature 1, because the frequency/ratio of racks loaded into the buckets A and C tends to increase, a lifespan of the buckets A and C tends to be shorter than that of the buckets B and D.

The present invention has been made in view of the above background, and an objective thereof is to provide an automatic centrifuge that applies a load equally to each bucket with multiple-time centrifugal separation operations by changing a loading rule of loading racks into the buckets for each centrifugal separation operation.

Another objective of the present invention is to provide an automatic centrifuge that equalizes a load applied to each mounting hole of a rotor with multiple-time centrifugal separation operations by changing a loading rule of loading specimen accommodating containers into the mounting holes of the rotor for each centrifugal separation operation.

Still another objective of the present invention is to provide an automatic centrifuge that changes, for each operation, a bucket (loading start bucket) to load a rack firstly or a mounting hole to mount a specimen accommodating container firstly during multiple-time centrifugal separation operations.

### Problem to be Solved by Invention

Representative features of the invention disclosed in this application are described as follows.

According to a feature of the present invention, an automatic centrifuge includes: a specimen accommodating container storing a sample; a rotor including a plurality of storage parts that store a plurality of racks holding the specimen accommodating container; a drive device rotationally driving the rotor; a door enabling access to a specific mounting hole of the rotor; a handling apparatus performing mounting and removal of the rack into and from the storage part; and a control device controlling the drive device and the handling apparatus. In the automatic centrifuge, the control device loads the rack into the storage part according to a specific rule to create rotational symmetry in terms of mass by loading of the rack into the storage part. At this time, the control device sets the storage part, which is to be firstly loaded with the rack in a centrifugal separation operation, to be different from the storage part that was firstly loaded during an immediately preceding centrifugal separation operation. The rotor mounted is, for example, a swing rotor, and uses a bucket rotatably supported on the swing rotor as the storage part. The bucket is capable of accommodating a plurality of the racks. One bucket is capable of being loaded with a maximum of n (integer: n≥1) racks, and in a case where a total of the racks loaded into the buckets is an odd number, rotational balance of the rotor is maintained by mounting a dummy rack into the bucket.

According to another feature of the present invention, a total quantity m of the buckets is 4, (a) during a centrifugal separation operation of an even-numbered time, loading of the racks starts firstly from a 1st bucket, and (b) during a centrifugal separation operation of an odd-numbered time, loading of the racks starts firstly from a 2nd bucket. The handling apparatus includes: a first direction transport device moving the specimen accommodating container to the vicinity of the door; and a second direction transport device for transporting the specimen accommodating container conveyed over by a moving means into the bucket. The control device controls the first transport device and the second transport device to transport the bucket to the bucket which is positioned below an opening of the door and standing by.

According to still another feature of the present invention, an automatic centrifuge includes: a specimen accommodating container storing a sample; an angle rotor including a plurality of mounting holes for holding the specimen accommodating container; a drive device rotationally driving the angle rotor; a door enabling access to a specific mounting hole of the rotor; a handling apparatus performing mounting and removal of the specimen accommodating container into and from the mounting hole; and a control device controlling the drive device and the handling apparatus. In the automatic centrifuge, the control device loads the specimen accommodating container into the mounting hole according to a specific rule to create rotational symmetry in terms of mass by loading of the specimen accommodating container into the mounting hole, and sets a start position of the mounting hole, which is to be firstly loaded with the specimen accommodating container in a centrifugal separation operation, to be different from a start position of the mounting hole that was firstly loaded during an immediately preceding centrifugal separation operation. In addition, in a case where a quantity of the specimen accommodating containers loaded into the angle rotor is an odd number, rotational balance of the angle rotor is maintained by mounting a dummy container into the mounting hole. Furthermore, in a case where a total quantity of the specimen accommodating containers loaded into the angle rotor is S, in a next centrifugal separation operation, mounting of the specimen accommodating containers starts from the mounting hole at a position shifted by t positions (where t is an integer and 0<t<S) from the mounting hole that firstly accommodated the specimen accommodating container in an initial centrifugal separation operation. Each time multiple-time centrifugal separations are performed, the position of the mounting hole to start mounting is shifted regularly in a circumferential direction.

### Effects of Invention

According to the present invention, in an automatic centrifuge, when repeating a series of centrifugal actions including loading racks into buckets, executing centrifugal separation operation, and taking out racks from buckets, a centrifugal load of racks applied to each bucket becomes approximately equal. As a result, a bias in a bucket lifespan due to the centrifugal load can be relieved. In addition, even in the case of using an angle rotor without buckets, it is possible to prevent an increase in frequency of use of a specific mounting hole, and it is possible to extend a lifespan of the angle rotor.

### BRIEF DESCRIPTION OF THE DRAWINGS

FIG. 1 is a perspective view of an automatic centrifuge 1 according to an embodiment of the present invention, showing main portions in a see-through view.

FIG. 2 is a top view of the automatic centrifuge 1 according to the embodiment of the present invention, showing a part in a see-through view.

FIG. 3 is a block circuit diagram of a control device of the automatic centrifuge 1 according to the embodiment of the present invention.

FIG. 4 is a perspective view of a bucket 50 in FIG. 1.

FIG. 5 is a perspective view of a rack 60 and specimen accommodating containers 70 in FIG. 1.

FIG. 6 is a layout view showing a loading status of the rack 60 into the bucket 50 of the automatic centrifuge 1 according to the embodiment of the present invention.

FIG. 7 is tables showing loading start buckets and loading sequences of the racks 60 into the buckets 50 of the automatic centrifuge 1 according to the embodiment of the present invention.

FIG. 8 is a flowchart showing a control procedure of a handling apparatus 20 of the automatic centrifuge 1 according to the embodiment of the present invention.

FIG. 9 is a perspective view showing an angle rotor 140 for an automatic centrifuge according to a second embodiment of the present invention.

FIG. 10 is a perspective view showing a conventional automatic centrifuge 201.

FIG. 11(a) is a layout view showing a loading status of a rack into a bucket 250 in the conventional automatic centrifuge, and (b) is a table showing a loading start bucket and a loading sequence of loading into the buckets in the conventional automatic centrifuge.

### DESCRIPTION OF THE EMBODIMENTS

### Embodiment 1

Herein, embodiments of the present invention will be described with reference to the drawings. In the following figures, same portions will be labeled with same reference signs, and repeated descriptions thereof will be omitted. In addition, in this specification, front, rear, left, right, up, and down directions will be described as directions shown in the figures.

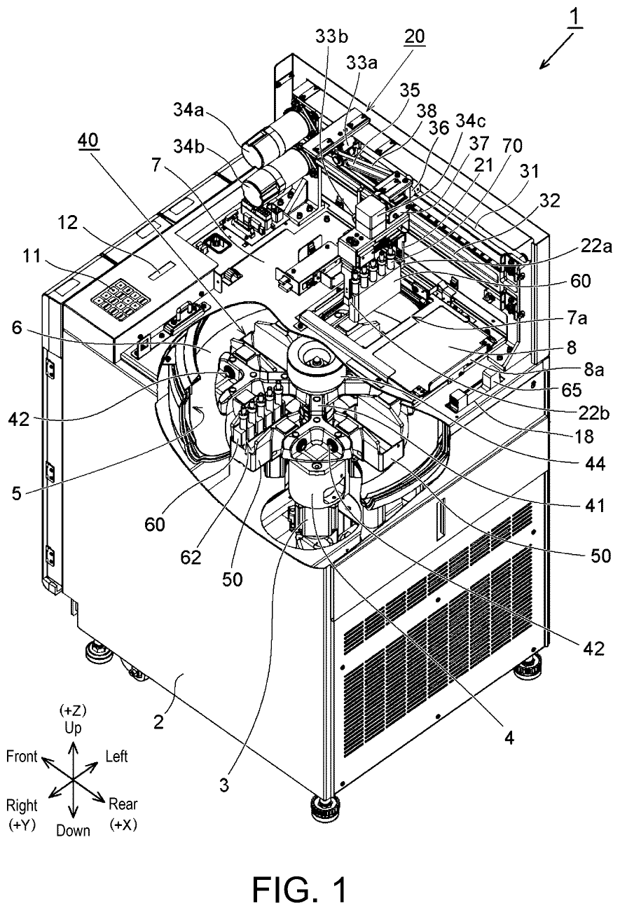

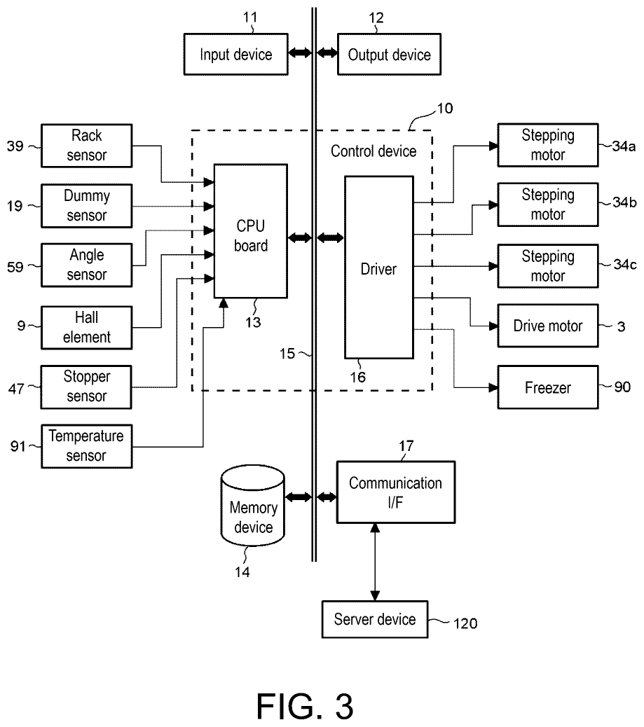

FIG. 1 is a perspective view of an automatic centrifuge 1 according to an embodiment of the present invention, showing main portions in a see-through view. The automatic centrifuge 1 includes a rotor 40 and a motor 3 rotating the rotor 40 inside a housing 2, and drives the motor 3 under rotation control of a control device 10 (refer to FIG. 3 to be described later) to perform centrifugal separation. An input device 11 performing an input operation from a user to the control device 10 and an output device 12 performing display of information to the user are provided on a front side of an upper surface of the housing 2. Although not shown in FIG. 1, a conveyance line 45 as illustrated in FIG. 10 is provided on a back surface side (back side) of the automatic centrifuge 1. A rotor room 6 is defined by a bowl 5 and an upper cover 7 that closes an upper-side opening of the bowl 5. The upper cover 7 is fixed to the housing 2 with screws, and a door (not shown) is provided at the upper cover 7 via a hinge. Maintenance and mounting/removal of the rotor 40 are performed with the door (not shown) opened. Furthermore, a small rectangular opening 7a is provided at a part of the upper cover 7, and a rack 60 is placed into and taken out from the rotor room 6 via the opening 7a. A slide-type door 8 capable of opening and closing is provided at the opening 7a to allow access to a specific storage part of the rotor 40. An opening/closing operation plate 8a, which is obtained by raising a metal plate of the slide-type door 8, is pushed by a tip of a hand 21 of a handling apparatus 20 under control of the control device 10 to perform an opening/closing action. The state in FIG. 1 indicates a state in which the door 8 is open, and carry-in and carry-out of the rack 60 with specimen accommodating containers 70 fixed thereto are performed via the opening 7a. A method of opening and closing the door 8 may be any method, and the door 8 may also be opened and closed (slid) by a motor (not shown) controlled by the control device 10.

A swing-type rotor is used as the rotor 40. The swing-type rotor 40 has four swing arms 41 extending in a Y-shape from a rotation shaft toward a radially outer side in a top view. Swing pins 42 are provided between adjacent swing arms 41, and four buckets 50 serving as storage parts are attached, each suspended at two swing pins 42. Each bucket 50 may be loaded with two racks 60 with specimen accommodating containers 70 set therein, and a total of eight racks 60 may be rotated in one centrifugal separation operation. A ball balancer 44 is provided on an upper side of the rotation shaft of the rotor 40 to adjust a balance of the rotor 40 during rotation by moving multiple balls (not shown) in a direction maintaining balance.

A motor 3 is provided on a lower side of the rotor 40 via a motor shaft case 4. Rotation of the motor 3 is controlled by the control device 10, and a conventional motor such as a brushless DC motor or an induction motor is used as the motor 3. A so-called encoder (not shown) is provided on a lower side of the motor 3 to detect a rotation angle of a rotation shaft of the motor 3. Such a motor 3 is generally called a servo motor, and the encoder outputs a Z-signal of 1 pulse/rotation, an A-phase pulse of, for example, 2048 pulses/revolutions, and a B-phase pulse that is 90 degrees shifted from the A-phase. From this pulse train, a rotation speed and a rotation angle of the motor 3 may be detected based on the Z-signal. Since the rotation shaft of the motor 3 and the rotor 40 are directly fixed with screws, the rotation angle of the motor 3 is the same as the rotation angle of the rotor 40. An offset angle between the Z-signal indicating a reference position of the motor 3 and a shift angle of a reference position of the rotor 40 is corrected by teaching adjustment. Herein, for convenience of description, to avoid complication due to use of the encoder, an angle sensor (not shown) detecting the rotation angle of the rotor 40 is provided on the lower side of the motor 3. In addition, a magnetic sensor (not shown) for detecting the rotation position of the rotor 40 is provided in the vicinity of a lower surface of the rotor 40, and the position (rotation angle from the reference position) of the rotor 40 may be detected by the control device 10. Although not shown in FIG. 1, a freezer 90 (not shown) (refer to FIG. 3) is provided to cool the inside of the rotor room 6, and a pipe-shaped evaporator (not shown) is wound around an outer circumference of the bowl 5 to circulate a refrigerant. A temperature of the rotor room 6 is measured by a temperature sensor 91 (refer to FIG. 3) provided on an inner side of the bowl 5 and is monitored by the control device 10. During centrifugal separation operation, and when the specimen accommodating containers 70 are accommodated in the rotor room 6, the rotor room 6 is maintained at a constant temperature under control of the control device 10.

The handling apparatus 20 is disposed along a left edge of an upper surface of the automatic centrifuge 1, and moves a moving member 37 in the +X direction to move the rack 60 using a link arm mechanism. The handling apparatus 20 includes a first guide member 31 and a second guide member 32 parallel to each other, and is provided with a first slider 33a sliding on the first guide member 31 and a second slider 33b sliding on the second guide member 32 to constitute a link arm mechanism. The first slider 33a is fixed to a timing belt (not visible in the figure) and moves in the +X direction or −X direction by rotating a stepping motor 34a. Similarly, the second slider 33b is also fixed to a timing belt (not visible in the figure) and moves in the +X direction or −X direction by rotating a stepping motor 34b. In addition, one end of a first arm 35 is pivotally attached to the first slider 33a, and similarly, one end of a second arm 36 is pivotally attached to the second slider 33b. The other end of the first arm 35 and the other end of the second arm 36 are pivotally attached coaxially to the moving member 37 which includes the hand 21. Furthermore, the moving member 37 and the first slider are pivotally attached by a parallel link 38 parallel to the first arm 35, and a posture of the moving member 37 during rising and lowering is maintained to be constant.

As described above, the moving member 37 is pivotally attached by tips of the first arm 35 and the second arm 36, and since lengths of the first arm 35 and the second arm 36 are the same, a shape is formed in which an apex of an isosceles triangle is the moving member 37, and a base is formed between the first slider 33a and the second slider 33b. By rotating the stepping motors 34a and 34b to control the positions of the first slider 33a and the second slider 33b, the moving member 37 is moved in the up-down direction (+Z direction). In this specification, the +X direction is defined as a first direction, and the +Z direction is defined as a second direction. Furthermore, a gripping mechanism is provided to move fingers 22a and 22b at both ends of the hand 21 to narrow or widen a spacing between the fingers 22a and 22b, and a stepping motor 34c (refer to FIG. 3) is provided to drive the gripping mechanism. The finger 22a may move in the +Y direction, the finger 22b may move in the +Y direction, and the fingers 22a and 22b move synchronously in directions opposite to each other. By using multiple stepping motors 34a, 34b, and 34c in this manner, the hand 21 becomes movable upward and downward (+Z direction). By narrowing the spacing in the left-right direction (Y direction), it becomes possible to grip the rack 60. Furthermore, by widening the spacing in the left-right direction (Y direction), it becomes possible to release the gripped rack 60. The handling apparatus 20 is provided with a rack sensor 39 (refer to FIG. 3) and the like to detect whether there is a gripping target between the fingers 22a and 22b, and the detection result is sent to the control device 10. The control device 10 controls a movement operation of the fingers 22a and 22b according to an output from the rack sensor 39. The specimen accommodating containers 70 are often labeled with identification marks such as barcodes, but to prevent occurrence of mix-ups of specimens, it is important to perform control such that a sequence in which the racks 60 are lined up on the conveyance line 45 does not change before and after the automatic centrifugal separation operation.

A dummy rack placement area 18 for accommodating one dummy rack 65 is provided in one region on the upper surface of the automatic centrifuge 1. The dummy rack 65 has an external shape in a same shape as the rack 60, is not formed with accommodating holes (refer to 61a to 61e in FIG. 5), and is in a shape capable of being loaded into the bucket 50 without rattling. In the case where a quantity of the racks 60 to be loaded onto the rotor 40 is an odd number, the dummy rack 65 is loaded by the handling apparatus 20 into a predetermined bucket 50 from a retreat position (dummy rack placement area 18) of the dummy rack. After the centrifugal separation operation, the dummy rack 65 is returned from the bucket 50 to the dummy rack placement area 18.

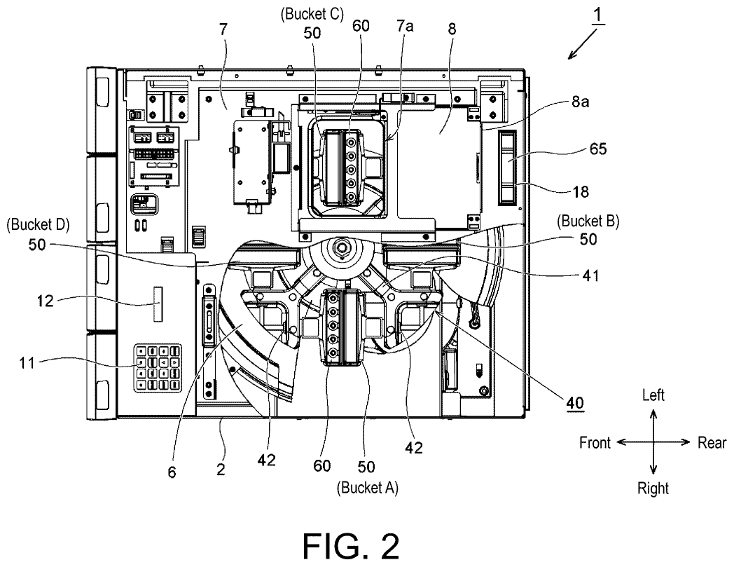

FIG. 2 is a top view of the automatic centrifuge 1, showing a portion in a see-through view. The handling apparatus 20 is not shown in FIG. 2. Although not shown herein, the conveyance line 45 shown in FIG. 10 is provided on a rear side of the automatic centrifuge 1. Multiple racks 60 transported from the conveyance line 45 are sequentially loaded into the buckets 50 by the handling apparatus 20 shown in FIG. 1. The opening 7a is formed at a part of the upper cover 7, and the slide-type door 8 is provided at the opening 7a. The door 8 opens and closes by moving the moving member 37 in the front-rear direction in a state in which the hand 21 provided at the moving member 37 of the handling apparatus 20 is abutted against the opening/closing operation plate 8a. A size of the opening 7a has an opening area sufficient for carry-in and carry-out the rack 60, and is a size that does not allow removal of one bucket 50. Thus, even if the bucket 50 is lifted together when taking out the rack 60, only the rack 60 can be taken out.

FIG. 2 shows a state in which a 2nd rack 60 is loaded into the bucket 50 (herein, one side of a bucket C). In the rotor 40 shown in FIG. 2, the quantity of the buckets 50 is four, and each bucket 50 is capable of accommodating two racks 60, so a maximum quantity of the racks 60 capable of undergoing centrifugal separation operation at once is eight. Regarding loading of the racks 60 into the buckets, a loading position of an odd-numbered rack 60 is mounted at a position rotationally symmetric to a loading position of an even-numbered rack 60, such that mass balance is maintained with respect to the rotation axis. Immediately after the 2nd rack 60 is loaded, a bucket A, which is at a position opposite to the bucket C across the rotation axis A1, is in a state mounted with the rack 60. On the other hand, a bucket B and a bucket D are in a state in which racks 60 have not been loaded.

Multiple magnets (not visible in the figure) integrally mounted are provided at a lower part of the rotor 40, and an initial position (not shown) in the rotation direction of the rotor 40 is detected by detecting a position of the magnet with a hall element 9 disposed on the rotor room side. The control device 10 rotates and positions the rotor 40 such that each bucket 50 sequentially comes to a position (90-degree rotation position, 180-degree rotation position, 270-degree rotation position from the origin) at which the rack 60 is carried in and out. After all the racks 60 to undergo centrifugal separation operation are loaded into the buckets 50, the rotor room 6 is closed with the door 8 horizontally moving to a front side to cover the opening 7a from the position shown in the figure. In the case where the quantity of the loaded racks 60 is an odd number, the dummy rack 65 is loaded lastly.

FIG. 3 is a block circuit diagram of the automatic centrifuge 1 according to the embodiment of the present invention. The control device 10 is configured to include a CPU board 13 and a driver 16. The CPU board 13 is connected with an input device 11, an output device 12, a memory device 14, and a communication interface (I/F) 17 via a data bus 15. The input device 11 is configured to include a keyboard-type input means shown in FIG. 1. The output device 12 is configured to include a liquid crystal display device shown in FIG. 1. The input device 11 and the output device 12 may also be configured as a liquid crystal touch panel display instead of separate configurations as shown in FIG. 1, or may also be configured to use a separate portable terminal such as a smartphone as an input/output device.

The CPU board 13 is mounted with a processor for executing computer programs. The CPU board 13 is configured in a board form mounted with a microcomputer, a read only memory (ROM), a random access memory (RAM), a non-volatile memory, etc. (not shown). Parts in the control device 10 are connected to each other by the data bus 15. The memory device 14 is a non-volatile secondary storage device such as a hard disk device or a flash memory. The communication interface 17 is a conventional interface device for connecting to a LAN, the Internet, or other public networks, and is connected to, for example, an external server device 120.

The control device 10 is provided with a driver 16 for driving each motor. The microcomputer included in the CPU board 13 controls rotation of each motor via the driver 16. The handling apparatus 20 is configured to include three motors, namely, stepping motors 34a, 34b, and 34c. The stepping motors 34a and 34b are the motors shown in FIG. 1, and are driving sources for moving the moving member 37 in the front-rear direction (+X direction) and the up-down direction (+Z direction). The stepping motor 34c is a motor that serves as a driving source for moving the two fingers 22a and 22b connected to the hand 21 in the left-right direction (+Y direction) to a gripping direction or a releasing direction. The motor 3 for driving is a motor that serves as a driving source for controlling the rotation and the rotation position of the rotor 40. In addition, the freezer 90 is a device for cooling the rotor room 6 and is configured to include a motor for operating a compressor.

To drive the stepping motors 34a, 34b, and 34c, and the motor 3 for driving the rotor 40, signals from various sensors are inputted to the CPU board 13. The rack sensor 39 is a sensor that detects whether a bucket 50 is present between the hands 21. A dummy sensor 19 is a sensor that detects whether the dummy rack 65 is placed in the dummy rack placement area 18. An angle sensor 59 is a sensor that detects the rotation angle of the rotor 40 from the reference position (position of rotation angle 0 degrees). The hall element 9 is disposed directly below the rotor 40 and is a sensor for detecting an ID of the rotor 40 and the rotation speed of the rotor 40. A stopper sensor 47 is a sensor for detecting whether a rack 60 is present at the carry-in/out position of the conveyance line 45. The temperature sensor 91 is a sensor for detecting the temperature of the rotor room 6.

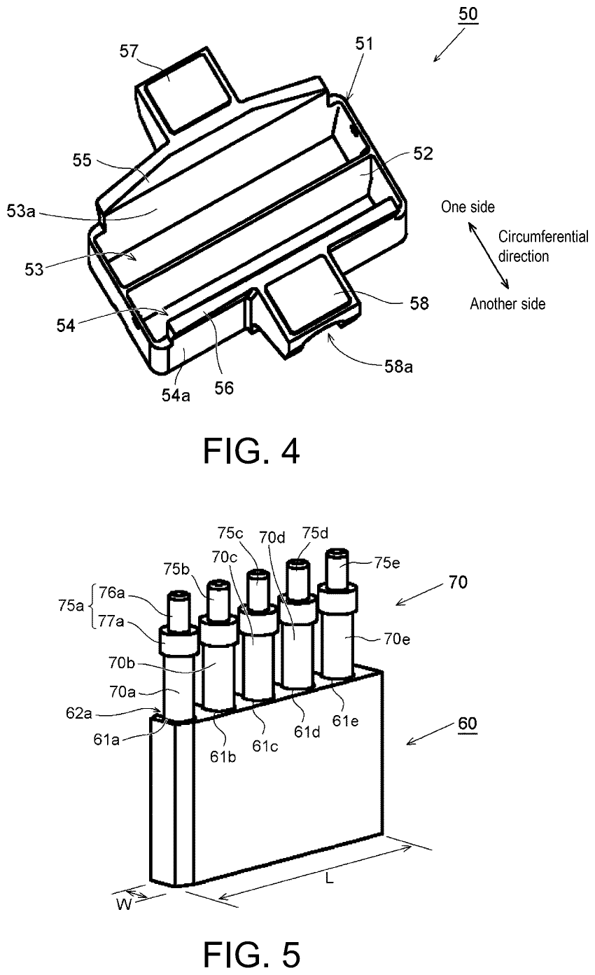

FIG. 4 is a perspective view of the bucket 50 in FIG. 1. The bucket 50 is a member suspended at the swing arm 41 of the rotor 40 with two racks 60 loaded therein. The bucket 50 is, for example, manufactured with an integral piece of metal such as aluminum alloy. The bucket 50 has an opening 51 at the top, and is formed with a partition wall 52 extending in a direction orthogonal to a swing axis direction from the opening 51 to a bottom surface. The partition wall 52 divides an internal space of the bucket 50 into two parts including a first accommodating part 53 and a second accommodating part 54. Sizes of the first accommodating part 53 and the second accommodating part 54 are in an equal shape, and sizes of an opening portion and a bottom surface portion in a rectangular shape have a volume and a shape optimal for loading the rack 60 (refer to FIG. 5) to be described later, and the accommodated rack 60 is maintained without rattling against the bucket 50.

On an upper side of a sidewall part 53a of a long side of the first accommodating part 53 of the bucket 50, a connection wall 55 is formed, and a pin receiving part 57 extending from an upper end of the connection wall 55 to one side in the rotation direction is formed. Similarly, on an upper side of a sidewall part 54a of a long side of the second accommodating part 54, a connection wall 56 is formed, and a pin receiving part 58 extending from an upper end of the connection wall 56 to another side in the rotation direction is formed. A swing bearing part 58a of a semi-cylindrical surface for suspending at the swing pin 42 (refer to FIG. 2) formed at the swing arm 41 of the rotor 40 is formed on a lower side of the pin receiving part 58. Similarly, a swing bearing part 57a (not visible in the figure) is also formed on a lower side of the pin receiving part 57.

FIG. 5 is a perspective view of the rack 60 in FIG. 1 and five specimen accommodating containers 70 (70a to 70e) loaded into the rack 60. A specimen sample collected in the specimen accommodating container 70 is, for example, human blood, and the specimen accommodating container 70 is what is called a vacuum blood collection tube. The specimen accommodating containers 70a to 70e are tubular containers made of glass or synthetic resin, have a circular opening surface (not visible in the figure) on an upper side, and have a hemispherical bottom part (not visible in the figure) on a lower side. In a state of FIG. 5, a state is shown in which the opening surfaces of the five specimen accommodating containers 70a to 70e are closed by caps 75 (75a to 75e). The cap 75a is formed by a lid part 76a and a knob part 77a. The cap 75 may be made of synthetic resin.

The rack 60 is a member for holding multiple specimen accommodating containers 70 in an upright state in one row, and may be mounted with five specimen accommodating containers 70a to 70e. The rack 60 is manufactured by integral molding of metal or synthetic resin. Since the rack 60 is automatically conveyed by the conveyance line 45, a size thereof is formed with a width W corresponding to a width W₁ of a conveyance path of the conveyance line 45 (W₁>W).

In addition, a length L of a long-side portion of the rack 60 is set to match the size of the first accommodating part 53 and the second accommodating part 54 of the bucket 50 to be loaded. This is because the size of the bucket 50, especially a distance between the swing pins 42, is limited by the size of the rotor 40 which rotates.

The rack 60 is formed with five accommodating holes 61a to 61e for mounting the specimen accommodating containers 70. The accommodating holes 61a to 61e are cylindrical holes in a shape similar to the shape of the specimen accommodating containers 70, and bottom parts (not visible in the figure) thereof are in a hemispherical shape similar to the bottom parts of the specimen accommodating containers 70. On the other hand, a cutout part 62a (refer also to FIG. 1) which is cut is formed on one side as viewed from a center axis of the cylindrical part. Although not visible due to being on a back side in the perspective view of FIG. 5, cutout parts 62b to 62e (not visible in the figure) in the same shape as the cutout part 62a are also formed on lateral surfaces of the accommodating holes 61b to 61e. Although a maximum of five specimen accommodating containers 70 is accommodated in the rack 60 herein, a rack 60 in an optimal size and an optimal shape is prepared to match the size of the bucket 50 mounted on the rotor 40, and further to match the size of the specimen accommodating container 70 to be used. Since the specimen accommodating containers 70 are placed in an upright state into the rack 60, after the centrifugal separation operation, serum of the blood moves to the upper side, and blood clot moves to the bottom side.

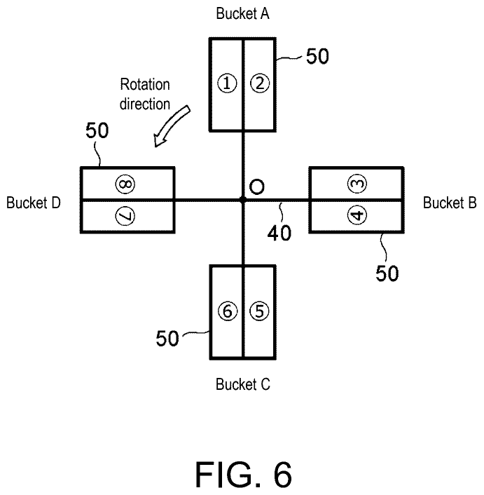

FIG. 6 is a layout view showing a loading status of the rack 60 into the bucket 50 of the automatic centrifuge 1 according to the embodiment of the present invention. Herein, the figure schematically shows a state in which four buckets 50 shown in FIG. 4 are set at the swing arms 41 of the rotor 40 rotating around the rotation axis O. Each bucket 50 is formed with two accommodating parts (first accommodating part 53 and second accommodating part 54 in FIG. 4), and is capable of storing two racks 60. To identify the buckets 50 and storage positions, the buckets 50 are indicated as A, B, C, and D along the rotation direction (hereinafter referred to as a “bucket A”, a “bucket B”, a “bucket C”, and a “bucket D”). In addition, for convenience of description, the accommodating parts of the four buckets 50 formed at the swing arms 41 are sequentially indicated by circled numbers, namely, circled 1 to circled 8, in a sequence as viewed in the rotation direction.

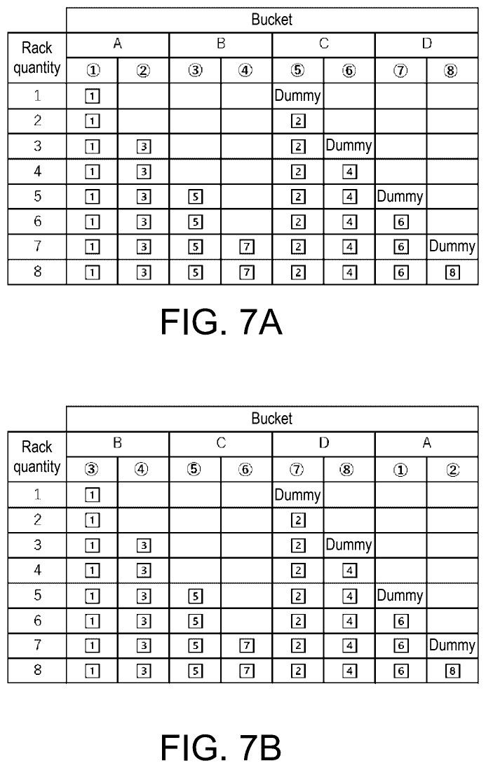

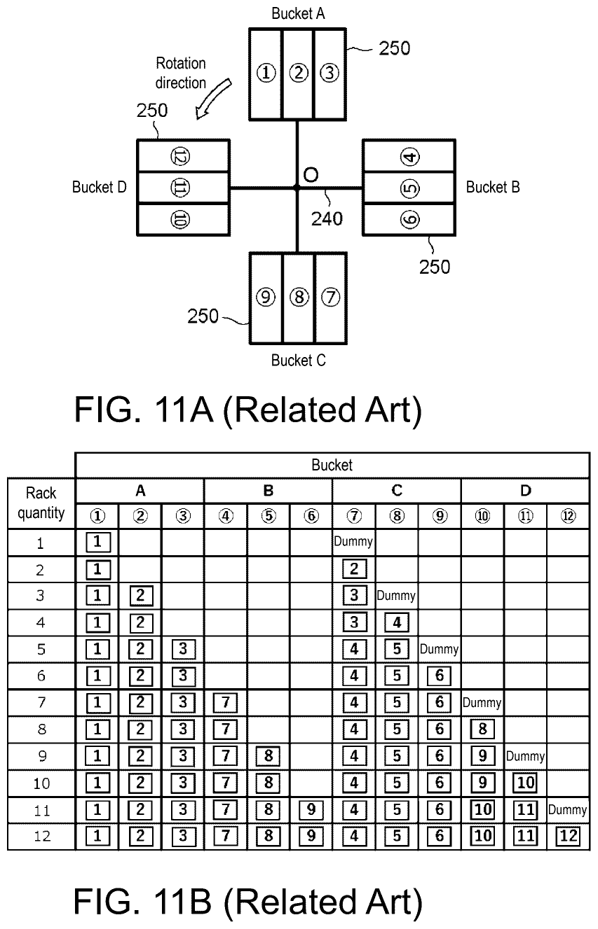

FIG. 7 is tables showing loading starting buckets and loading sequences of loading the racks 60 into the buckets 50. In a conventional automatic centrifuge, as described in FIG. 11(b), loading of multiple racks 60 loaded with the specimen accommodating containers 70 sent over from the conveyance line 45 always starts from the bucket A. In other words, a loading start position of the rack 60 is fixed to the bucket A, which is located directly below the opening 7a (refer to FIG. 2) when the rotor 40 is at a reference rotation position (rotation angle 0 degrees).

Although the bucket 50 at the position of rotation angle 0 degrees of the rotor 40 has been fixed as the “loading start position” in this manner, in the present embodiment, the “loading start position” is changed each time centrifugal separation operation is performed. For example, the bucket A is taken as the loading start position in an odd-numbered time of centrifugal separation operation, and the next bucket B, which is at the position of rotation angle 90 degrees of the rotor 40, is taken as the “loading start position” in an even-numbered time of centrifugal separation operation.

A loading rule of the racks 60 after the loading start position is set is the same for an odd-numbered time and an even-numbered time. In other words, looking at the centrifugal separation operation of an odd-numbered time shown in FIG. 7(a), a 2nd rack 60 is loaded into the bucket C, which is at a position to which the rotor 40 has rotated 180 degrees from the position of the 1st bucket A. As can be learned by referring to FIG. 6, the positions of circled 1 and circled 5 are positions 180 degrees opposite to each other based on the rotation axis O, that is, in a rotationally symmetric relationship. A 3rd rack 60 is loaded into the bucket A, which is at a position to which the rotor 40 has rotated 180 degrees again. A 4th rack 60 is loaded into the bucket C, which is at a position to which the rotor 40 has rotated 180 degrees again. In this manner, after completing loading of the racks 60 into the two buckets A and C at rotationally symmetric positions, if a next rack 60 is conveyed over, the control device 10 rotates the rotor 40 by 270 degrees to position the bucket B under the opening 7a.

Next, the control device 10 starts loading of the racks 60 into the buckets B and D, taking the bucket B as a reference. A 5th rack 60 is loaded into the position of circled 3 of the bucket B. A 6th rack 60 is loaded into the position of circled 7 of the bucket D, which is at a position to which the rotor 40 has rotated 180 degrees. A 7th rack 60 is loaded into circled 4 of the bucket B, which is at a position to which the rotor 40 has rotated 180 degrees again. A last 8th rack 60 is loaded into circled 8 of the bucket D, which is at a position to which the rotor 40 has rotated 180 degrees again. In this manner, upon ending of loading of the racks 60 into the two buckets B and D at rotationally symmetric positions, loading of all the eight racks 60 into the buckets 50 is ended.

FIG. 7(b) is a table for describing loading positions and a loading sequence into the buckets 50 in an even-numbered time. The difference from FIG. 7(a) is that the loading start position of a 1st rack 60 is changed from the bucket A to the bucket B, which is at a position to which the rotor 40 has been rotated 90 degrees. The loading rule of the racks 60 after the bucket B is taken as the loading start position is the same as the loading rule shown in FIG. 7(a) when viewed in a relative positional relationship. In the case where the quantity of the racks 60 to be loaded is an odd number, one dummy rack 65 is loaded lastly to maintain the rotational balance of the rotor 40.

As described above, in this embodiment, when performing centrifugal separation operations of 1st to n-th times (where n is a positive integer), the bucket that serves as the loading start position is changed between the case of a centrifugal separation operation of an even-numbered (2n-th) time and the case of a centrifugal separation operation of an odd-numbered ((2n+1)-th) time. The loading start positions and the loading rules in an odd-numbered time and an even-numbered time shown in FIG. 7(a) and (b) are stored in advance in the memory device 14 in a table format, a program format, or a parameter format. The microcomputer included in the control device 10 determines which of the buckets 50, i.e., which of the buckets A to D, to start loading firstly, and then loads the loading positions relative from the bucket 50 according to rules of the loading rule. In addition, in the case where a maximum of n (integer of N>1) racks 60 may be loaded into all the buckets 50, if the total quantity of the racks 60 to be loaded into the buckets 50 is an odd number, the rotational balance of the rotor 40 is maintained by loading the dummy rack into the bucket 50.

In the case where the quantity of the buckets 50 capable of being mounted on the swing-type rotor 40 is six (in the case of buckets A to F), the loading rule shown in FIG. 7 is set as three patterns. In a centrifugal separation operation of a (3n+1)-th time (where n is a positive integer), the bucket A is taken as the loading start position; in a centrifugal separation operation of a (3n+2)-th time, the bucket B is taken as the loading start position; and in a centrifugal separation operation of a (3n+3)-th time, the bucket C is taken as the loading start position. In the case of six buckets 50, it is important to prepare two dummy racks. Even in cases where the quantity of the buckets 50 capable of being mounted on the rotor 40 is a quantity other than 4 or 6, it is sufficient to configure to sequentially change the position of the bucket 50 to start loading of the racks 60 each time a centrifugal separation operation is performed. In addition, dummy racks of a quantity corresponding to the quantity of the buckets may be prepared.

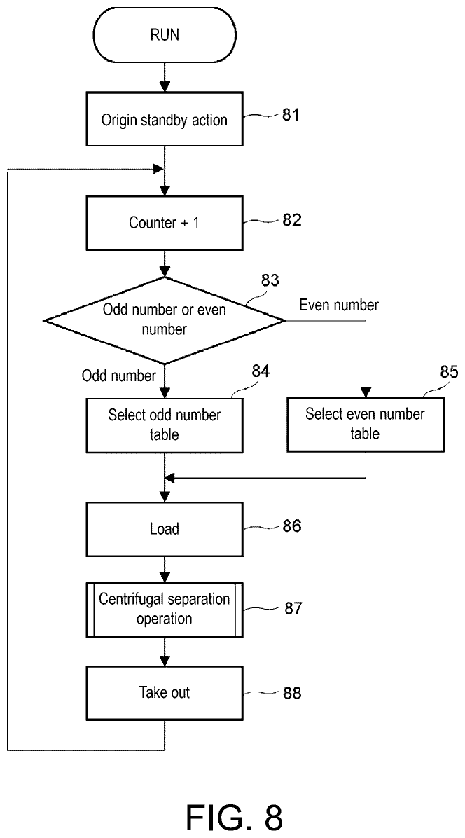

FIG. 8 is a flowchart showing a control procedure of the handling apparatus 20 of the automatic centrifuge 1 according to the embodiment of the present invention. These procedures are implemented in software by the microcomputer included in the control device 10 executing a computer program. The procedure shown in the flowchart of FIG. 8 is automatically started when a power of the automatic centrifuge 1 is turned ON. Firstly, in response to instructions from the control device 10, an origin standby action is performed (step 81). In origin standby, the stepping motors 34a to 34c for driving the link arms are energized, and the handling apparatus 20 starts an origin return action. In the origin return action, the hand 21 is kept stationary at an initial position at which the hand 21 is moved to the upper side in the vertical direction. In addition, the control device 10 clears, to zero, a value of a counter N for counting which time of centrifugal separation operation it has been since the power is turned ON, or maintains the value of the counter N at a predetermined value or sets the value of the counter N.

Next, by driving the stepping motors 34a and 34b, the control device 10 moves the first slider 33a and the second slider 33b to move the moving member 37 to a pickup position of the rack 60 on the conveyance line 45. The control device 10 picks up an initial rack 60 by the handling apparatus 20 and increments the counter N which counts which time of centrifugal separation operation it is (step 82). Then, the control device 10 determines whether the value of the counter N is an odd number or an even number (step 83). In the case where the value of the counter N indicating which time of centrifugal separation operation it is is an odd number, the table of an odd-numbered time shown in FIG. 7(a) is selected (step 84), and in the case where the value is an even number, the table of an even-numbered time shown in FIG. 7(b) is selected (step 85).

Next, the control device 10 sequentially loads multiple racks 60 into the buckets 50 according to the loading sequence specified in the table selected in step 84 or 85 (step 86). Herein, the motor 3 for driving the rotor 40 is controlled to rotate the rotor 40 at a low speed of 20 rpm level, and rotates the rotor 40 until the bucket 50 into which the rack 60 is to be firstly set comes to below the opening 7a. Then, the handling apparatus 20 is operated to transport the rack 60 from the conveyance line 45 and load the rack 60 into the bucket 50. Next, by controlling the motor 3 to rotate the rotor 40 by 180 degrees or 270 degrees, the control device 10 moves the bucket 50 to load a next rack 60 to below the opening 7a. The above actions are repeated to load the racks 60 of one-time centrifugal separation operation into the buckets 50.

Upon completion of loading of all the racks 60 into the buckets 50, the control device 10 closes the door 8 of the opening 7a and then performs centrifugal separation operation according to set centrifugal separation operation conditions (step 87). In the centrifugal separation operation, the inside of the rotor room 6 is maintained at a predetermined low temperature, and the rotor 40 is accelerated and stabilized at a set rotation speed to perform the operation of a set duration. After a predetermined centrifugation duration, for example, 5 minutes, has elapsed, deceleration of the rotor begins. After the rotor completely stops and the centrifugal separation operation ends, an action of carrying the racks 60 out from inside the centrifuge is executed according to a carry-out action instruction from the control device 10. Upon stop of the rotor 40, the control device 10 rotates the rotor 40 until the bucket 50 from which the rack 60 is to be firstly taken out comes to below the opening 7a, opens the door 8, and then sequentially takes out the racks 60 (step 88). In the take-out process of the racks 60, the racks 60 are sequentially moved to the conveyance line 45 in the same sequence as the loading process, and are automatically transported to a destination by the conveyance line 45.

Regarding the sequence of carrying out the racks 60 from the buckets 50, carry-out is performed in a sequence of carry-in based on the sequence of carry-in and location data of carry-in stored in the memory device 14. For example, the action of take-out of the racks 60 may be configured to first carry out from the buckets A and C in the case of an odd-numbered time, or carry out from the buckets B and D in the case of an even-numbered time, to return in a sequence of conveying to the conveyance line 45. It is also possible to configure the take-out sequence to be in any sequence, or to return the buckets 50 to the conveyance line 45 without specifying a sequence. After carrying out all the racks 60, in the case where the dummy rack 65 is used, the dummy rack 65 is returned to the original dummy rack placement area to wait for the carry-in action instruction for a next centrifugal separation operation. In this manner, the carry-in, centrifugation, and carry-out actions described above are repeatedly executed. The control device 10 may operate the freezer (not shown) to maintain the inside of the rotor room 6 at a constant set temperature not only during the centrifugal separation operation, but also during the carry-in before the centrifugal separation operation and during the carry-out after the centrifugal separation operation.

According to the procedure described above, in the present embodiment, during multiple-time centrifugal separation operations, by changing the loading start position of the racks 60 into the buckets 50 in an odd-numbered time and the loading start position of the racks 60 into the buckets 50 in an even-numbered time, it becomes possible to relieve an overload state with respect to the buckets A and C and apply a similar load also to the buckets B and D. Thus, it becomes possible to extend a lifespan of the four buckets A to D.

### Embodiment 2

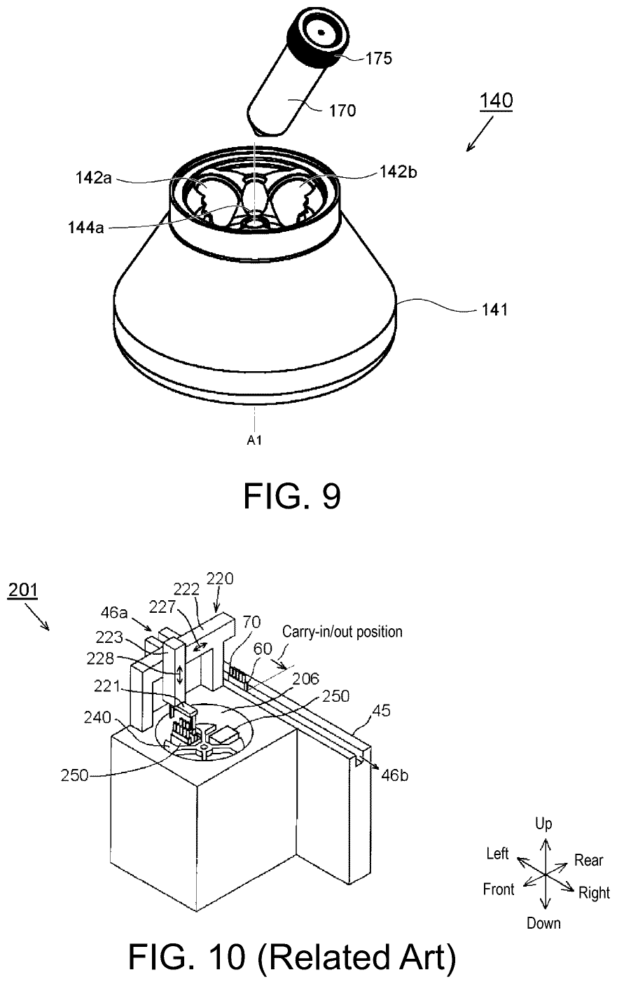

In the first embodiment, an example of a swing rotor holding multiple (herein, four) buckets 50 has been described as the rotor 40. However, the type of the rotor 40 serving as a provided target of the present invention is any type, is not limited to application to a swing rotor only, and may be similarly applied to an angle rotor 140. The angle rotor 140 shown in FIG. 9 is “T15A41 Angle Rotor (product name)” sold by the applicant. A rotor body 141 of the angle rotor 140 is an integral metal piece, formed with multiple mounting holes into which large specimen accommodating containers 170 or small specimen accommodating containers (not shown) are mounted. The specimen accommodating container 170 is a sample container that is sealed by a lid part 175. The angle rotor 140 is formed with four mounting holes 142a to 142d (however, 142c and 142d are not visible in FIG. 9) for the specimen accommodating containers 170, and four mounting holes 144a to 144d (however, the mounting holes 142b to 142d are not visible in FIG. 9) for small-diameter specimen accommodating containers, and one to four specimen accommodating containers 170 or one to four small-diameter specimen accommodating containers (not shown) may be mounted. Individual specimen accommodating containers 170 are automatically transported from a conveyance line by a handling apparatus (not shown) and sequentially loaded into the multiple mounting holes in a predetermined sequence. The handling apparatus used is, for example, of a robot arm type.

The handling apparatus (not shown) mounts an initial specimen accommodating container 170 into the mounting hole 142a, mounts a next specimen accommodating container 170 into the mounting hole 142c (not visible in the figure) at a position 180 degrees apart from the mounting hole 142a, mounts a next specimen accommodating container 170 into the mounting hole 142b disposed between the mounting hole 142a and the mounting hole 142c, and mounts a last specimen accommodating container 170 into the mounting hole 142d (not visible in the figure). In the case where the quantity of the specimen accommodating containers 170 to be mounted is an odd number, a dummy container (not shown) in a shape almost the same as the specimen accommodating container 170 is mounted to maintain rotational balance. The dummy container (not shown) is used for the same purpose as the dummy rack 65 in the first embodiment, and is a mass body having an average weight of the specimen accommodating container 170 filled with a sample. In a second-time centrifugal separation operation, the loading start position of the specimen accommodating containers 170 is changed, and the mounting hole to mount an initial specimen accommodating container 170 is the mounting hole 142b. Similarly, in a third-time centrifugal separation operation, the mounting hole to mount an initial specimen accommodating container 170 is the mounting hole 142c, and in a fourth-time centrifugal separation operation, the mounting hole to mount an initial specimen accommodating container 170 is the mounting hole 142d. If the loading start position of the specimen accommodating container 170 is sequentially changed for each centrifugal separation operation in this manner, concentration of a load on a specific mounting hole (especially the mounting hole 142a) only can be effectively avoided.

As shown in the second embodiment, even in the case of using the angle rotor 140, with a configuration in which the mounting hole for starting loading is sequentially changed for each centrifugal separation operation to prevent concentration of the load on a specific mounting hole and apply a load almost equally to each mounting hole, durability of the angle rotor 140 can be improved. In the first embodiment and the second embodiment, the loading sequence has been shown to be divided into two data tables. However, multiple data tables (not shown) may also be prepared corresponding to the quantity of the buckets (A to D) or the quantity of the mounting holes to select a data table for each centrifugal separation operation.

Although the present invention has been described based on two embodiments, the present invention is not limited to the above embodiments, and various modifications are possible within a scope without deviating from the spirit thereof. For example, in the above embodiments, the loading start position of loading into each bucket is set regularly, but the loading start position may also be changed randomly for each loading. Specifically, the loading start position of the bucket A is circled 1, and when loading is performed next time, loading may start from circled 2 or another bucket. By doing so, the load can be distributed even in the case of operating with only one rack in the bucket.

### REFERENCE SIGNS LIST

1: automatic centrifuge
2: housing
3: motor
4: motor shaft case
5: bowl
6: rotor room
7: upper cover
7a: opening
8: door
8a: opening/closing operation plate
9: hall element
10: control device
11: input device
12: output device
13: CPU board
14: memory device
15: data bus
16: driver
17: communication interface
18: dummy rack placement area
19: dummy sensor
20: handling apparatus
21: hand
22a, 22b: finger
31: first guide member
32: second guide member
33a: first slider
33b: second slider
34a to 34c: stepping motor
35: first arm
36: second arm
37: moving member
38: parallel link
39: rack sensor
40: rotor
41: swing arm
42: swing pin
44: ball balancer
45: conveyance line
47: stopper sensor
50: bucket
51: opening
52: partition wall
53: first accommodating part
53a: sidewall part
54: second accommodating part
54a: sidewall part
55, 56: connection wall
57, 58: pin receiving part
57a, 58a: swing receiving part
59: angle sensor
60: rack
61, 61a to 61e: accommodating hole
62a to 62e: cutout part
65: dummy rack
70, 70a to 70e: specimen accommodating container
75, 75a to 75e: cap
76a to 76e: closure lid part
77a to 77e: knob part
90: freezer
91: temperature sensor
110: server device
140: angle rotor
141: rotor body
142a to 142d: mounting hole
170: specimen accommodating container
175: lid part
201: automatic centrifuge
206: rotor room
220: handling apparatus
221: hand
222, 223: transport device
240: swing rotor
250: bucket

1. An automatic centrifuge comprising:
a specimen accommodating container storing a sample;
a rotor comprising a plurality of storage parts that store a plurality of racks holding the specimen accommodating container;
a drive device rotationally driving the rotor;
a door enabling access to a specific storage part of the rotor;
a handling apparatus performing mounting and removal of the rack into and from the storage part; and
a control device controlling the drive device and the handling apparatus, wherein
the control device is configured to:
load the rack into the storage part according to a specific rule to create rotational symmetry in terms of mass by loading of the rack into the storage part, and
set the storage part, which is to be firstly loaded with the rack in a centrifugal separation operation, to be different from the storage part that was firstly loaded during an immediately preceding centrifugal separation operation.

2. The automatic centrifuge according to claim 1, wherein
the rotor is a swing rotor, and uses a bucket rotatably supported on the swing rotor as the storage part, and
the bucket is capable of accommodating a plurality of the racks.

3. The automatic centrifuge according to claim 2, wherein
the bucket is capable of being loaded with a maximum of n racks, and in a case where a quantity of the racks loaded into the buckets is an odd number, rotational balance of the rotor is maintained by mounting a dummy rack into the bucket.

4. The automatic centrifuge according to claim 3, wherein
a total quantity m of the buckets is 4,
(a) during a centrifugal separation operation of an even-numbered time, loading of the racks starts firstly from a 1st bucket, and
(b) during a centrifugal separation operation of an odd-numbered time, loading of the racks starts firstly from a 2nd bucket.

5. The automatic centrifuge according to claim 4, wherein
the handling apparatus comprises:
a first transport device moving the specimen accommodating container to the vicinity of the door; and
a second transport device for transporting the specimen accommodating container conveyed over by the first transport device into the bucket, and
the control device controls the first transport device and the second transport device to transport the specimen accommodating container into the bucket which is standing by below the door.

6. An automatic centrifuge comprising:
a specimen accommodating container storing a sample;
an angle rotor comprising a plurality of mounting holes for holding the specimen accommodating container;
a drive device rotationally driving the angle rotor;
a door enabling access to a specific mounting hole of the angle rotor;
a handling apparatus performing mounting and removal of the specimen accommodating container into and from the mounting hole; and
a control device controlling the drive device and the handling apparatus, wherein
the control device is configured to:
load the specimen accommodating container into the mounting hole according to a specific rule to create rotational symmetry in terms of mass by loading of the specimen accommodating container into the mounting hole, and
set a start position of the mounting hole, which is to be firstly loaded with the specimen accommodating container in a centrifugal separation operation, to be different from a start position of the mounting hole that was firstly loaded during an immediately preceding centrifugal separation operation.

7. The automatic centrifuge according to claim 6, wherein
in a case where a quantity of the specimen accommodating containers loaded into the angle rotor is an odd number, rotational balance of the angle rotor is maintained by mounting a dummy container into the mounting hole.

8. The automatic centrifuge according to claim 7, wherein
in a case where a total quantity of the specimen accommodating containers loaded into the angle rotor is S,
in a next centrifugal separation operation, mounting of the specimen accommodating containers starts from the mounting hole at a position shifted by t positions from the mounting hole that firstly accommodated the specimen accommodating container in an initial centrifugal separation operation, where t is an integer and 0<t<S.

9. An automatic centrifuge comprising:
a specimen accommodating container storing a sample;
a rotor comprising a plurality of storage parts that store a plurality of racks holding the specimen accommodating container;
a drive device rotationally driving the rotor;
an opening enabling access to a specific storage part of the rotor; and
a control device controlling the drive device,
the rack being loaded into the storage part via the opening by a handling apparatus, wherein
the control device is configured to:
load the rack into the storage part according to a specific rule to create rotational symmetry in terms of mass by loading of the rack into the storage part, and
set the storage part, which is to be firstly loaded with the rack in a centrifugal separation operation, to be different from the storage part that was firstly loaded during an immediately preceding centrifugal separation operation.
